(19) United States
(12) Patent Application Publication
(10) Pub. No.: US 2008/0270440 A1
(43) Pub. Date: Oct. 30, 2008

(54) Data Compression for Producing Spectrum Traces

(75) Inventors: Yi He, Portland, OR (US); Kathryn A. Engholm, Portland, OR (US)

Correspondence Address: MATTHEW D. RABDAU;TEKTRONIX, INC., 14150 S.W. KARL BRAUN DRIVE, P.O. BOX 500 (50-LAW), BEAVERTON, OR, 97077-0001, US

(73) Assignee: TEKTRONIX, INC., Beaverton, OR (US)

(21) Appl. No.: 12/092,251

(22) PCT Filed: Nov. 1, 2006
(86) PCT No.: PCT/US2006/060456

§ 371 Date: Apr. 30, 2008

Related U.S. Application Data
(60) Provisional application No. 60/733,844, filed on Nov. 4, 2005.

(51) Int. Cl. G06F 17/30

(52) U.S. Cl. 707/101; 707/E17.002

(57) ABSTRACT

A data compression method for producing spectrum traces may divide signal data into multiple transform frames, produce a spectrum trace for each transform frame using a time domain to frequency domain transform, and combine the multiple frames from the analysis window into a single spectrum trace according to the spectrum amplitude of corresponding points in each frame. A device comprising a port to receive a signal or data set; and circuitry in communication with the port to segment the data record into frames, multiply each frame by a windowing function, transform each frame from a time domain representation to a frequency domain representation, and compress the frames using a detection function to create a single spectrum trace. This data compression provides flexibility to allow users to select analysis length, resolution bandwidth (RBW) and number of trace points independently, eliminating the coupling often found in traditional approaches.

### CROSS REFERENCE TO RELATED APPLICATIONS

This application claims the benefit of U.S. Provisional Application No. 60/733,844, filed Nov. 4, 2005, the entire contents of which are incorporated herein by this reference for all purposes.

### BACKGROUND

With the fast proliferation of digital communication technologies and other high performance systems, it becomes important for test and measurement software and instrumentation to provide correlated analysis and displays of time, frequency and modulation domains of electrical, acoustic, or optical waveforms. For example, modern communication systems are characterized by time bursts, frequency hops and complex digital modulation schemes.

Spectrum analyzers are often used to examine the spectral composition of subject waveforms or signals. Traditional swept spectrum analyzers use a superheterodyne receiver where a local oscillator is swept through a range of frequencies. Modern spectrum analyzers can transform sampled signal data records into spectrum waveforms by means of a Fast Fourier transform (FFT) or similar mathematical process. A vector signal analyzer is a tool specifically designed for digital modulation analysis by providing both magnitude and phase information for analyzed signals.

Referring to FIG. 1, spectrum analyzers collect an acquisition record 110 comprising a block of data samples and users can analyze either the entire record or a portion of the record collectively over the time, frequency and modulation domains. The analyzed portion of the acquisition record 110 is an analysis window 120 and the analysis window duration is often referred to as analysis length. Analysis length is typically set according to the desired measurements.

The width of the narrowest filter in the intermediate frequency (IF) stages of a spectrum analyzer is often referred to as the resolution bandwidth (RBW). The RBW determines the analyzer's ability to resolve closely spaced signal components. For vector signal analysis, the RBW of the spectrum is inversely proportional to the time duration of the transform frame.

The desired analysis window may often contain multiple transform frames. For example, a user may choose an RBW that requires only a short analysis time, but might also want to select an analysis length that is several times longer than what the RBW needs. Partial data can be used to produce a requested RBW. Alternately, an entire data set can be used, resulting in a different RBW than requested, therefore in conventional approaches if a user wants a specific analysis time, the RBW is also decided or adjustment of RBW may not even be allowed.

### BRIEF DESCRIPTION OF THE DRAWINGS

FIG. 1 illustrates an acquisition record of sampled data including an analysis window.

FIG. 2 illustrates a signal record that is divided into multiple frequency transform frames.

FIG. 3 illustrates an embodiment that provides data compression for producing spectrum traces.

FIG. 4 illustrates trace compression being used to reduce a number of intermediate traces to requested trace points for multiple frequency transform frames.

FIG. 5 illustrates an embodiment detector mode to combine frequency frames into a single spectrum trace.

FIG. 6 illustrates an embodiment method to combine frequency frames into a single spectrum trace.

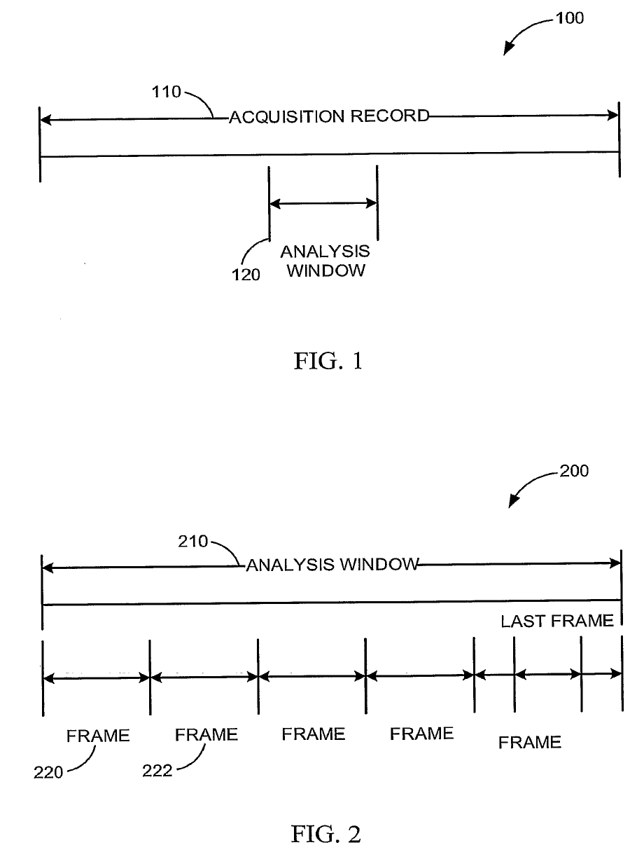

### DETAILED DESCRIPTION

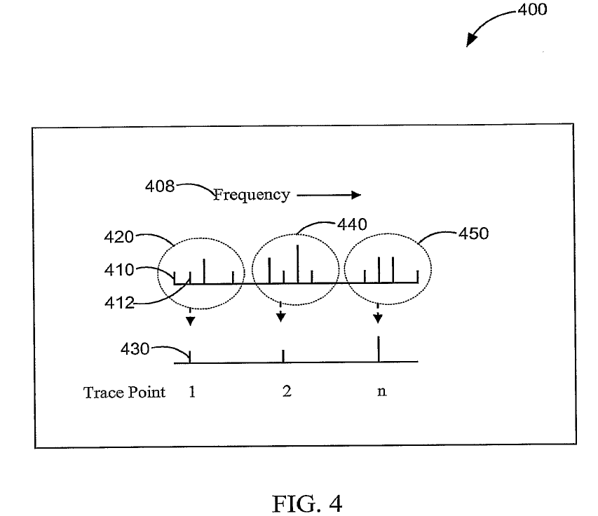

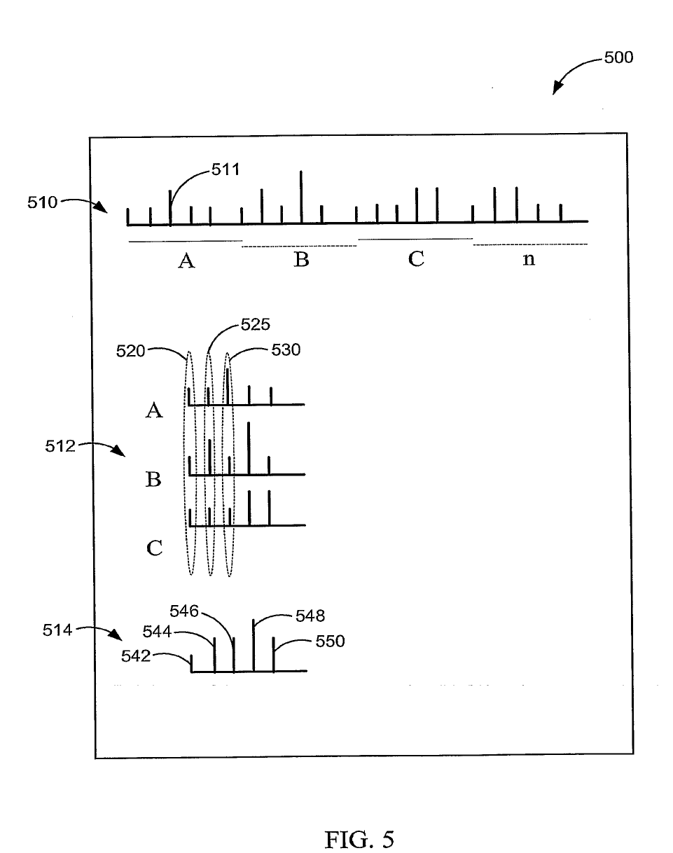

The present disclosure provides a system and method for using data compression to produce a spectrum trace. In one embodiment, data compression and frequency transform techniques may be used to produce spectrum traces from digitized amplitude vs. time data on a spectrum analyzer. These principles provide more analysis flexibility by allowing a spectrum analyzer to decouple analysis length, resolution bandwidth (RBW) and waveform trace points. In some embodiments, trace compression can be used to combine the multiple frequency transform frames into a single spectrum trace with desired display trace points, as will be explained more fully with reference to FIG. 4 and FIG. 5. Trace compression is sometimes referred to as detection.

FIG. 2 illustrates an analysis window 210 divided into multiple frequency transform frames. After a contiguous signal record is acquired, the signal record can then be divided into multiple frequency transform frames 220. In some embodiments, a signal record may be selected from a larger record according to the analysis length defined by the user. Each frame 220, 222, can then be transformed from the time domain to the frequency domain using a Chirp-z transform, a FFT transform or any other suitable transforms.

In some embodiments, a windowing function such as Kaiser, Flattop, Gaussian, Hann, Blackman-Harris (several versions), Hamming, Blackman, Uniform, etc., may be applied to the data within an individual transform frame to combat spectrum leakage. After applying a windowing function, a spectrum is computed from each transform frame using a transform.

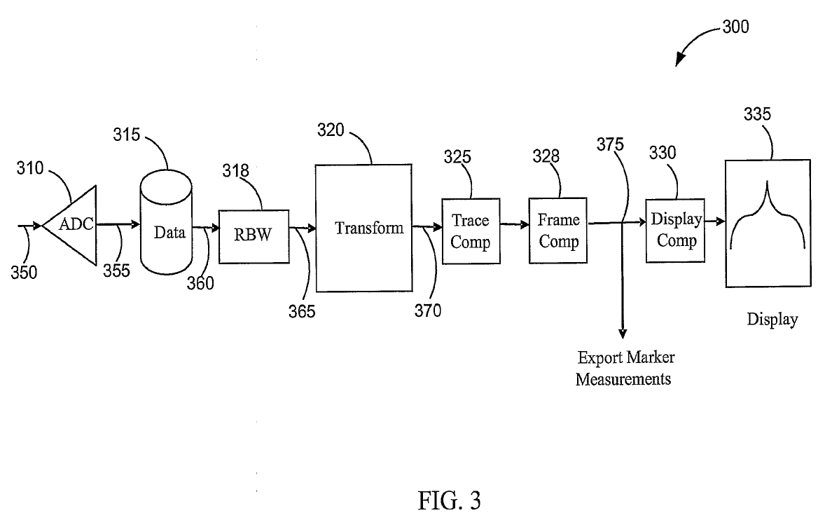

FIG. 3 illustrates an embodiment 300 for producing spectrum traces with data compression. Analog to digital converter (ADC) 310 receives an analog signal 350, and outputs time-domain digital data records to data store 315. The present embodiment illustrates an ADC 310 on the front end of the processing path, but other embodiments may receive digital data directly without the need for ADC 310 and are also applicable to any spectrum analyzer with different architecture.

The data records then are transferred block 318 to be parsed into RBW block sizes. The RBW data blocks are then sent to transform block 320 to be transformed from time domain records 365 to frequency domain records 370. As discussed above, the present embodiment utilizes a Chirp-z transform, but other embodiments may use an FFT or any other suitable transform.

If the trace points are less than k*Fs/RBW, where k is a window-related coefficient and approximately 2 for Blackman-harris-4B window, and Fs is the sample frequency corresponding to the requested span, the trace points may be increased to greater than k*Span/RBW. One method is to multiply the current trace points by an integer number to create intermediate trace points 410 in FIG. 4. The number of intermediate trace points 410 may be chosen such that it is greater than k*Span/RBW. This step reduces, or eliminates, missed signal peaks in the spectrum display for arbitrary trace point input.

Following the Chirp-z transform in transform block 320, trace compression may be used to reduce the number of points in each spectral frame 410 to the number of trace points requested for each frequency transform frame.

FIG. 4 illustrates trace compression to reduce the number of points in each spectrum trace 410 to the number desired 412 for each frequency transform frame 420, 440 and 450. This step reduces, or eliminates, missed signal peaks when the number of trace points 412 is set to a value smaller than the number of samples in the RBW frame.

Referring back to FIG. 3, after transform block 320, frequency-domain records 370 are compressed in trace compression block 325 to compress each spectral frame to a desired number of trace points. After trace compression in block 325, multiple frames is compressed into a single spectrum trace in frame compression block 328 and then enters display compression block 330 and is sent to display 335 or to some other storage or processing device. Some embodiments may use data compression to produce a spectrum trace with other hardware, with software, or with various combinations of hardware and software, but are not restricted to the hardware as illustrated in FIG. 3.

In some embodiments, if an analysis length is not an exact multiple of the length of transform frames 420, 440 and 450, then the remaining part can be either ignored or the last transform frame can be overlapped with the second to last frame 440, or another frame. Also, in order to improve transient signal detection capability, the transform frames 420, 440 and 450 can all be overlapped to reduce the de-emphasis effect on the transform frame edges caused by a windowing function.

FIG. 5 illustrates a detector embodiment 500 to combine frequency frames A, B, C and D into a single spectrum trace 514. Different detector modes can be used based on the application being used, such as, maximum (positive peak), minimum (negative peak), average (mean, etc.), maximum/minimum (positive/negative peaks), normal, root mean square, quasi-peak or other detector modes that detect features of frequency frames and allows combining frames according to frame features.

Referring back to FIG. 3 as well as FIG. 5, frequency frames A, B, C and up to arbitrary frequency frame n can correspond to signals comprising RBW size blocks from RBW 318. After undergoing a time to frequency transform in transform block 320, frequency frames A-C may be combined using a detection function according to corresponding spectral components 520, 525 and 530 as depicted at 512. The example illustrated in FIG. 5 is a positive peak detection function, for example, spectral component 542 is the positive peak of the set of corresponding spectral components from frequency frames A, B and C.

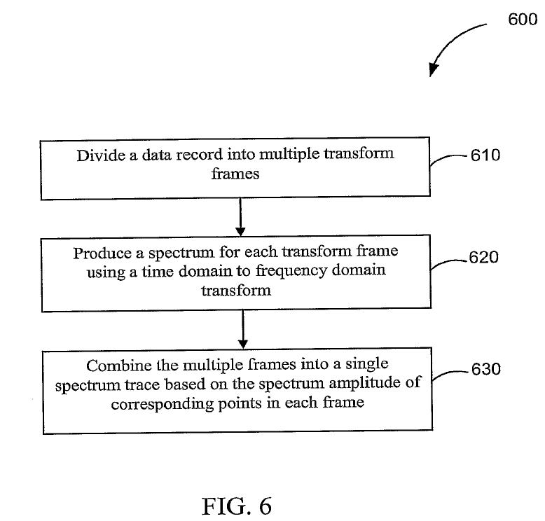

FIG. 6 illustrates an embodiment method 600 to combine frequency frames into a single spectrum trace. In block 610, method 600 divides analysis data into multiple transform frames as illustrated in FIG. 2. In some embodiments, the transform frame length is determined by k*Fs/RBW, where k is the window-related coefficient, Fs is the sample frequency corresponding to the requested span and is the same one used to determine the intermediate trace points. Additionally, some embodiments may then multiply each transform frame by a windowing function as described herein.

In block 620, spectrum is produced for each transform frame. In some embodiments a Chirp-z transform, FFT transform, or other suitable transform may be used to produce the spectrum. In an embodiment, a set of intermediate trace points is produced as described above in connection with FIG. 4. In an alternative embodiment no intermediate trace points are produced. If the intermediate points are used, a defined detector can be used to reduce each output spectrum trace to the desired trace points 430.

Method 600 may then combine multiple frames of spectrum data from the analysis window into a single spectrum trace based on the spectrum amplitude of corresponding points in each frame, as shown above in FIG. 5. Method 600 can produce a spectrum trace which satisfies both a requested RBW and desired trace points. Additionally, the entire data in an analysis window can be utilized to produce spectrum and a more coherent comparison can be made with other domain analyses. Also, by using detectors as a data compression technique, any abnormal spectrum activities are easy to identify.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

1. A method comprising:
dividing a data record into multiple transform frames;
producing a spectrum for each transform frame using a time domain to frequency domain transform; and
combining the multiple frames into a single spectrum trace based on the spectrum amplitude of corresponding points in each frame.

2. The method of claim 1 wherein the transform frames are a resolution bandwidth length.

3. The method of claim 1 wherein combining the multiple frames into a single spectrum trace comprises combining the frames based on at least one of positive peaks, negative peaks, average, positive/negative peaks, normal, root mean square, and quasi-peaks of spectrum amplitude.

4. The method of claim 1 wherein the source for the data record is an analog signal or a digital data set.

5. The method of claim 1 wherein the time domain to frequency domain transform is a Chirp-z transform.

6. The method of claim 1 wherein the time domain to frequency domain transform is a Fast Fourier Transform.

7. The method of claim 1, further comprising multiplying each transform frame by a windowing function.

8. A device comprising:
a port to receive a signal; and
circuitry in communication with the port, the circuitry to:
segment the digitized signal into frames;
transform each frame from a time domain representation to a frequency domain representation; and
compress the frames using a detection function to create a single spectrum trace.

9. The device of claim 8, wherein the frames are resolution bandwidth frames.

10. The device of claim 8, wherein the detection function is based on at least one of positive peaks, negative peaks, average, positive/negative peaks, normal, root mean square, and quasi-peaks of spectrum amplitude in each frame.

11. The device of claim 8, wherein the signal comprises an analog signal or a digital data record.

12. The device of claim 8, wherein the time domain to frequency domain transform is a Chirp-z transform.

13. The device of claim 8, wherein the time domain to frequency domain transform is a Fast Fourier Transform.

14. The device of claim 8, wherein the circuitry is further configured to multiply each frame by a windowing function.

15. A device comprising:
means for dividing signal data into multiple transform frames;
means for producing a spectrum for each transform frame using a time domain to frequency domain transform; and
means for combining the multiple frames from the analysis window into a single spectrum trace according to the spectrum amplitude of corresponding points in each frame.

16. The device of claim 15, wherein the transform frames are a resolution bandwidth length.

17. The device of claim 15, wherein the means for combining the multiple frames from the analysis window into a single spectrum trace comprises means for combining the frames based on at least one of positive peaks, negative peaks, average, positive/negative peaks, normal, root mean square, and quasi-peaks of spectrum amplitude.

18. The device of claim 15, wherein the signal data is an analog signal or a digital data record.

19. The device of claim 15, wherein the time domain to frequency domain transform is a Chirp-z transform.

20. The device of claim 15, wherein the time domain to frequency domain transform is a Fast Fourier Transform.

21. The device of claim 15, further comprising means for multiplying each transform frame by a window function.
